(19) United States
(12) Patent Application Publication
(10) Pub. No.: US 2008/0061921 A1
(43) Pub. Date: Mar. 13, 2008

(54) DEVICE TO INDICATE FUSE CAPACITY AND ELECTRONIC APPARATUS HAVING THE SAME

(75) Inventor: Young Seok KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/758,297

(22) Filed: Jun. 5, 2007

(30) Foreign Application Priority Data
Sep. 11, 2006 (KR) 2006-87537

(51) Int. Cl. H01H 85/04

(52) U.S. Cl. 337/297

(57) ABSTRACT

A device to indicate a fuse capacity includes a fuse, a printed circuit board (PCB), on which the fuse is mounted, and a capacity indicating part to expose one of different fuse capacities, corresponding to the fuse mounted on the PCB, and to shield other fuse capacities. Accordingly, the device can easily indicate the fuse capacity in electric apparatus which uses various fuses having different capacities on the PCB.

### CROSS-REFERENCE TO RELATED APPLICATIONS

This application claims priority under 35 U.S.C. §119(a) from Korean Patent Application No. 2006-0087537, filed on Sep. 11, 2006 in the Korean Intellectual Property Office, the disclosure of which is incorporated herein in its entirety by reference.

### BACKGROUND OF THE INVENTION

1. Field of the Invention

The present general inventive concept relates to a device to indicate a fuse capacity, and more particularly to a device to indicate a fuse capacity of two or more fuse capacities on the same PCB (Printed Circuit Board), and an electronic apparatus having the same.

2. Description of the Related Art

Generally, a conventional air conditioner is an apparatus for cooling or heating an indoor room, which comprises an indoor unit, an outdoor unit, and a refrigerant circulating the indoor and outdoor units. When the liquid state refrigerant is evaporated, the refrigerant absorbs environmental heat. When the gas state refrigerant is condensed, the refrigerant emits heat.

The air conditioner typically comprises one outdoor unit and one indoor unit which are connected to each other. Recently, as a living space is broadened and a demand of multi-functional air conditioners (e.g., which comprise one outdoor unit and two indoor units) is increased, products having various capacities have been developed and became popular.

Such an air conditioner is equipped with various electric devices such as a compressor, a fan motor and the like, and circuit elements for supplying power to the electric devices. The electric devices are provided with protecting devices for preventing malfunction by surge, over current, over voltage or the like. For example, there are an OCP (Over Current Protection), a SCP (Short Circuit Protection), and a fuse for protecting the electric devices from over load like over current, short current or the like.

Especially, the fuse is most commonly used in the electric devices. The fuse is mounted on a PCB and contains a piece of wire which melts when the over current is applied to electric circuits so that the flow of electricity stops. The fuse is mounted in a fuse block which includes a case which has terminals connected to the electric circuits and insulating components, and fuse connecting terminals for supporting both ends of the fuse.

FIG. 1 is a schematic view illustrating a conventional device for indicating a fuse capacity when a fuse 1 is mounted on a PCB 5Referring to FIG. 1, the fuse 1 is supported by a fuse block 3, and the fuse block 3 with the fuse 1 is mounted on PCB patterns 7 formed on the PCB 5. Lead members 3a protruding from a bottom of the fuse block 3 are fitted into PCB pattern holes 7a formed at the PCB patterns 7.

A fuse capacity indicating part 9, on which the fuse capacity is marked with intaglio characters, is formed on a side of the PCT pattern hole 7a on the PCB 5. As the capacity of the electric apparatus (e.g., an air conditioner) varies, the fuse capacity also varies. Accordingly, the fuse capacity indicating part 9, on which two or more various fuse capacities are marked, is formed on the PCB 5, so as to commonly use the PCB 5 in various electric apparatuses.

In order to indicate the capacity of the fuse 1 in the fuse block 3 which is actually installed on the PCB 5, except the corresponding fuse capacity mark, a delete line is drawn on the other fuse capacity mark on the fuse capacity indicating part 9, e.g., by using a pen, as illustrated in FIG. 2.

Because two or more fuse capacities are marked on the same capacity indicating part 9 which is mounted on the commonly used PCB 5, the non-used fuse capacity mark must be deleted.

However, because the deleting work of the non-used fuse capacity mark should be additionally performed after the fuse block 3 with the fuse 1 is mounted to the PCB pattern hole 7a, it takes much time for installation. Further, when the fuse capacity mark in use is deleted by mistake, it may make the installing process very troublesome.

### SUMMARY OF THE INVENTION

The present general inventive concept provides a device to easily indicate a fuse capacity in an electric apparatus which uses various fuses having different capacities on a PCB.

The present general inventive concept provides a device to indicate a fuse capacity which can easily indicate a capacity of a fuse mounted on a PCB according to a selective mounting position of the fuse at PCB patterns without an additional indicating process by modifying the PCB patterns on the PCB.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a device to indicate a fuse capacity, the device comprising a fuse, a printed circuit board (PCB), on which the fuse is mounted, and a capacity indicating part to expose one of different fuse capacities, corresponding to the fuse mounted on the PCB, and to shield the other fuse capacities.

The capacities of fuses mounted on the PCB may be different from each other.

The PCB may be formed with holes to determine a mounting position of the fuse on the PCB according to the fuse capacity.

The mounting position of the holes may include a first mounting position to indicate a first fuse capacity of the different fuse capacities and a second mounting position to indicate a second fuse capacity.

When the fuse is mounted to the first mounting position, the capacity indicating part may indicate the first fuse capacity, and when the fuse is mounted to the second mounting position, the capacity indicating part may indicate the second fuse capacity.

The capacity indicating part may indicate a capacity indicating plate, on which the different fuse capacities are marked, and a shielding plate which exposes one of the different fuse capacities marked on the capacity indicating plate, corresponding to the fuse mounted on the PCB, and shields the other fuse capacities.

The capacity indicating plate may be a circular plate capable of rotating or a moving plate capable of moving linearly.

The capacity indicating plate may be disposed between the shielding plate and the PCB shielding plate may be coupled to the PCB, and the shielding plate may be formed with an opening, through which the fuse capacity corresponding to the fuse mounted on the PCB is exposed.

The foregoing and/or other aspects of the present general inventive concept may also be achieved by providing an electronic apparatus including an electrical component, a printed circuit board, a fuse unit mounted on the printed circuit board to control a power to be supplied to the electrical component, and a capacity indicating part having a plurality of capacities formed on the PCB to expose one of the capacities to correspond to a fuse of the fuse unit and to shield the other one of the capacities.

### BRIEF DESCRIPTION OF THE DRAWINGS

These and/or other aspects and advantages of the exemplary embodiments of the general inventive concept will become apparent and more readily appreciated from the following description of the embodiments, taken in conjunction with the accompanying drawings, of which:

FIG. 1 is a schematic view illustrating a conventional device for indicating a fuse capacity when a fuse is mounted on a PCB;

FIG. 2 is a plan view illustrating the conventional device of FIG. 1;

FIG. 3 is a schematic view illustrating a device to indicate a fuse capacity of a fuse which is mounted on a PCB according to an embodiment of the present general inventive concept;

FIGS. 4A and 4B are plan views illustrating the device of FIG. 3 to indicate the fuse capacity;

FIG. 5 is a schematic view illustrating a device to indicate a fuse capacity of a fuse which is mounted on a PCB according to an embodiment of the present general inventive concept;

FIGS. 6A and 6B are plan views illustrating the device of FIG. for indicating a fuse capacity depicted in FIG. 5;

FIG. 7 is a schematic view illustrating a device to indicate a fuse capacity of a fuse which is mounted on a PCB according to an embodiment of the present general inventive concept;

FIG. 8 is a schematic view illustrating a device to indicate a fuse capacity of a fuse which is mounted on a PCB according to an embodiment of the present general inventive concept; and

FIG. 9 is a view illustrating an electronic apparatus having a device to indicate a fuse capacity according to an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

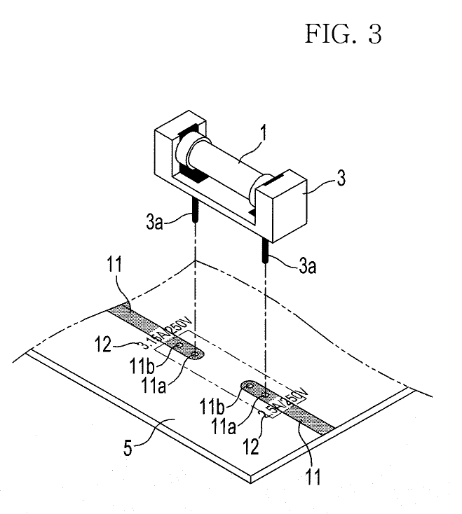

FIG. 3 is a schematic view illustrating a device to indicate a fuse capacity of a fuse 1 which is mounted on a PCB 5, according to an embodiment of the present general inventive concept.

Referring to FIG. 3, first and second PCB patterns 11 are formed on the PCB 5, and lower and upper PCB pattern holes 11a and 11b are formed at both the first and second PCB patterns 11. The lower and upper PCB pattern holes 11a and 11b are arranged in a longitudinal direction of the PCB patterns 11, and lead members 3a of a fuse block 3 are inserted into the PCB pattern holes 11a and 11b. Fuse capacity indicating parts 12, on which two different fuse capacities (e.g., 2.5A/250V and 3.15A/250V) are respectively marked with intaglio characters, are respectively formed near the lower and upper PCB pattern holes 11a and 11b at the first and second PCB patterns 11.

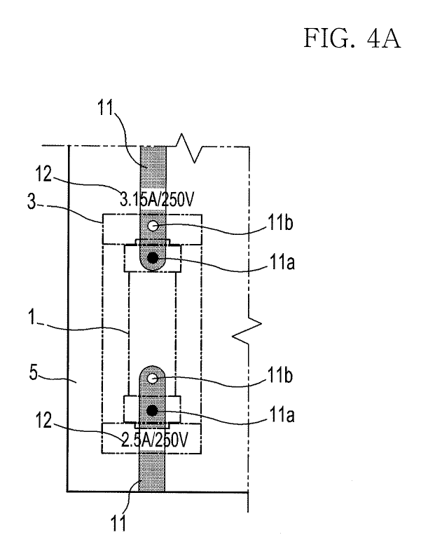

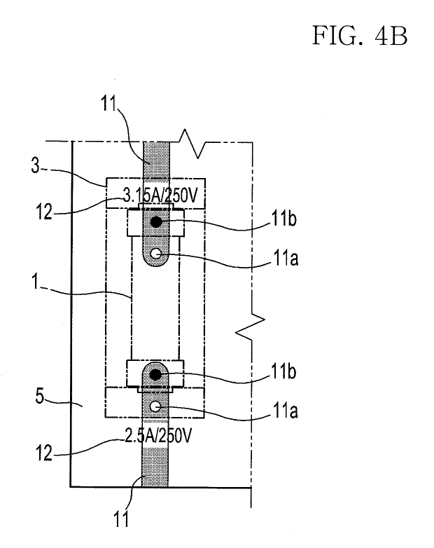

FIGS. 4A and 4B are plan views illustrating the device of FIG. 3 to indicate the fuse capacity of the fuse 1 . For example, as illustrated in FIG. 4A, when the fuse block 3 with the fuse 1 of 3.15A/250V is mounted to the lower PCB pattern holes 11a of the first and second PCB patterns 11, the non-used fuse capacity of 2.5A/250V is hidden by the fuse block 3, and only the fuse capacity in use of 3.15A/250V is visible. Accordingly, the fuse capacity in use of 3.15A/250V can be easily indicated by mounting the fuse block 3 to the lower PCB pattern holes 11a without an additional indicating process. The lower or upper PCB pattern holes 11a or 11b may be hidden by the fuse block 3 when the lead members 3a of the fuse block 3 are connected to the lower or upper PCB pattern holes 11a or 11b.

Also, as illustrated in FIG. 4B, when the fuse block 3 with the fuse 1 of 2.5A/250V is mounted to the upper PCB pattern holes 11b of the first and second PCB patterns 11, the non-used fuse capacity of 3.15A/250V is hidden by the fuse block 3, and only the fuse capacity in use of 2.5A/250V is visible. Accordingly, the fuse capacity in use of 2.5A/250V can be easily indicated by only mounting the fuse block 3 to the upper PCB pattern holes 11b without another additional indicating process.

As described above, the PCB patterns 11 formed with the lower and upper PCB pattern holes 11a and 11b on the PCB 5 may be used in various electric apparatuses (e.g., an air conditioner), according to a selective mounting position of the fuse 1 at the lower PCB pattern holes 11a or the upper PCB pattern holes 11b, and the capacity of the fuse 1 actually mounted on the PCB 5 can be easily indicated.

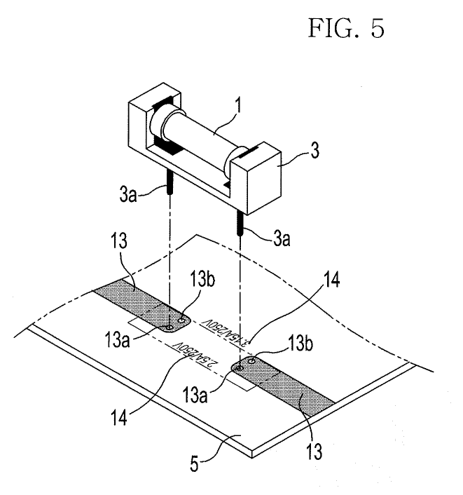

FIG. 5 is a schematic view illustrating a device to indicate a fuse capacity of a fuse 1 according to an embodiment of the present general inventive concept. The same elements of FIG. 5 are denoted by the same reference numerals of FIG. 3, and detailed description thereof will be omitted.

As illustrated in FIG. 5, first and second PCB patterns 13 are formed on a PCB 5, and left and right PCB pattern holes 13a and 13b are formed at both the first and second PCB patterns 13. The left and right PCB pattern holes 13a and 13b are arranged in a width direction of the PCB patterns 13, and lead members 3a of a fuse block 3 are inserted into the PCB pattern holes 13a and 13b. Fuse capacity indicating parts 14, on which two different fuse capacities (e.g., 2.5A/250V and 3.15A/250V) are respectively marked with intaglio characters, are formed on left and right sides of the PCB pattern holes 13a and 13b.

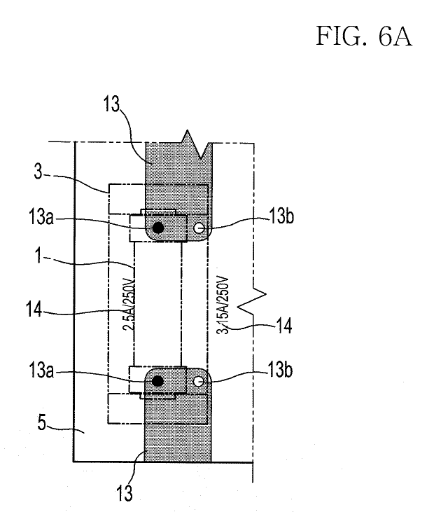

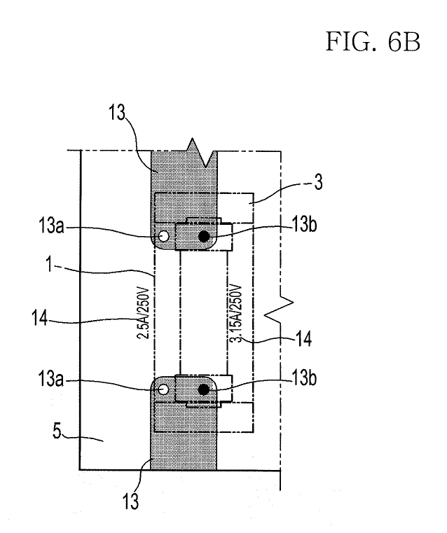

FIGS. 6A and 6B are plan views illustrating the device of FIG. 5. For example, as illustrated in FIG. 6A, when the fuse block 3 with the fuse 1 of 3.15A/250V is mounted to the left PCB pattern holes 13a of the first and second PCB patterns 13, the non-used fuse capacity of 2.5A/250V is hidden by the fuse block 3, and only the fuse capacity in use of 3.15A/250V is visible. Accordingly, the fuse capacity in use of 3.15A/250V can be easily indicated by only mounting the fuse block 3 to the left PCB pattern holes 13a without an additional indicating process.

Also, as illustrated in FIG. 6B, when the fuse block 3 with the fuse 1 of 2.5A/250V is mounted to the right PCB pattern holes 13b of the first and second PCB patterns 13, the non-used fuse capacity of 3.15A/250V is hidden by the fuse block 3, and only the fuse capacity in use of 2.5A/250V is visible. Accordingly, the fuse capacity in use of 2.5A/250V can be easily indicated by only mounting the fuse block 3 to the right PCB pattern holes 13b without another additional indicating process.

As described above, the PCB patterns 13 formed with the left and right PCB pattern holes 13a and 13b on the PCB 5 may be used in various electric apparatuses (e.g., an air conditioner), according to a selective mounting position of the fuse 1 at the left PCB pattern holes 13a or the right PCB pattern holes 13b, the capacity of the fuse 1 actually mounted on the PCB 5 can be easily indicated.

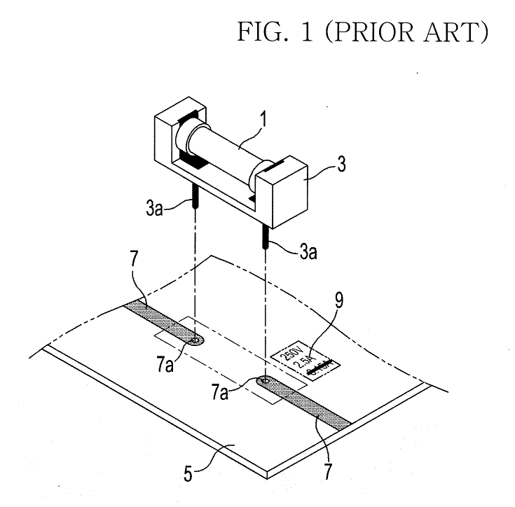

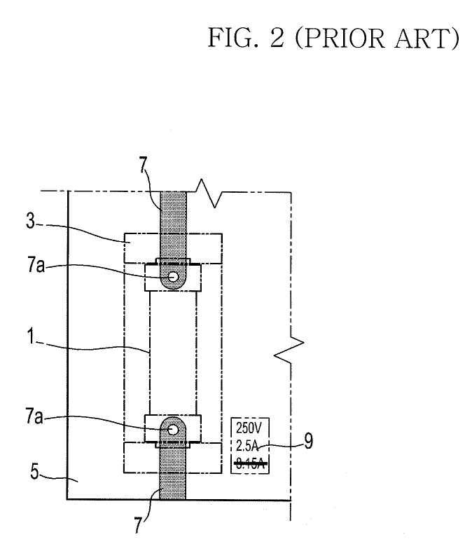

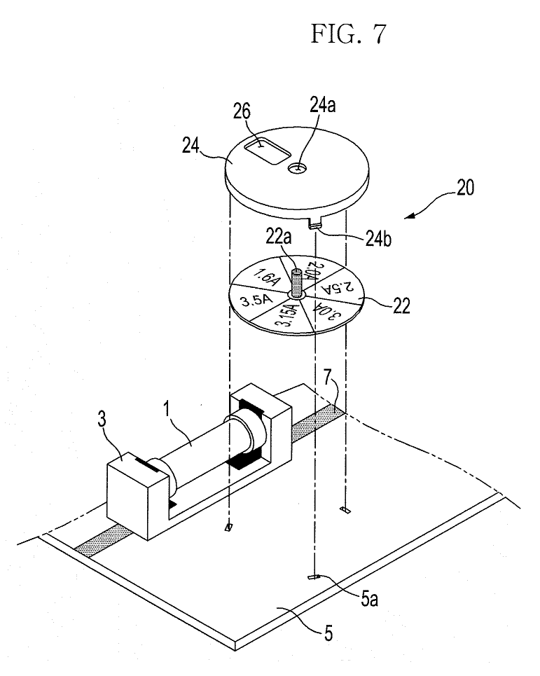

FIG. 7 is a schematic view illustrating a device to indicate a fuse capacity according to an embodiment of the present general inventive concept. The same elements of FIG. 1 are denoted by the same reference numerals of FIG. 7, and detailed description thereof will be omitted.

As illustrated in FIG. 7, PCB patterns 7 may be formed on a PCB 5 in the same structure as a conventional device of FIG. 1. A fuse capacity indicating part 20 is installed on a side of PCB pattern holes 7a (see FIG. 1) on which a fuse block 3 with a fuse 1 is mounted.

The fuse capacity indicating part 20 includes a circular moving plate 22 (hereinafter, which will be called a capacity indicating plate), on which two or more different fuse capacities are marked with intaglio characters, and a circular fixing plate 24 (hereinafter, which will be called a shielding plate), which is formed with an opening 26. The circular moving plate 22 may be a circular rotating plate. Only one of capacities marked on the capacity indicating plate 22, which corresponds to the fuse 1 mounted to the PCB 5, is exposed through the opening 26, and the other non-used capacities are shielded by the shielding plate 24. The shielding plate 24 is formed with a through-hole 24a at a center thereof, and a rotating shaft 22a formed at a center of the capacity indicating plate 22 is inserted through the through-hole 24a of the shielding plate 24, so that the capacity indicating plate 22 can be rotated. Further, the shielding plate 24 is formed with one or more coupling protrusions 24b at a circumference thereof. The coupling protrusions 24b extend downward to be fitted in PCB holes 5a formed at the PCB 5 to be coupled to the PCB 5.

For example, when the fuse block 3 with the fuse 1 of 3.15A/250V is mounted to the PCB pattern holes 7a, the capacity indicating plate 22 is rotated so that the corresponding fuse capacity of “3.15A” marked on the capacity indicating plate 22 is exposed through the opening 26 of the shielding plate 24.

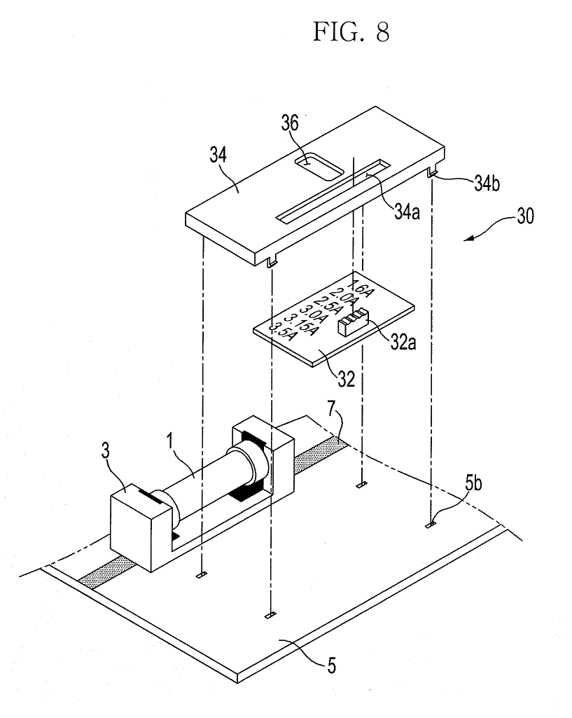

FIG. 8 is a schematic constitution view illustrating a device to indicate a fuse capacity according to an embodiment of the present general inventive concept. The same elements of FIG. 1 are denoted by the same reference numerals of FIG. 8, and detailed description thereof will be omitted.

As illustrated in FIG. 8, PCB patterns 7 are formed on a PCB 5 in the same structure as a conventional device of FIG. 1. A fuse capacity indicating part 30 is installed on a side of PCB pattern holes 7a (see FIG. 1) on which a fuse block 3 with a fuse 1 is mounted.

The fuse capacity indicating part 30 includes a rectangular moving plate 32 (hereinafter, which will be called a capacity indicating plate), on which two or more different fuse capacities are marked with intaglio characters, and a rectangular fixing plate 34 (hereinafter, which will be called a shielding plate), which is formed with an opening 36. Only one of the capacities marked on the capacity indicating plate 22, which corresponds to the fuse 1 mounted to the PCB 5, is exposed through the opening 36, and the other non-used capacities are shielded by the shielding plate 34. The shielding pate 34 is formed a guide slot 34a, and the capacity indicating plate 32 is formed with a knob 32a which is inserted through the guide slot 34a. The knob 32a moves linearly along the guide slot 34a. Further, the shielding plate 34 is formed with coupling protrusions 34b at a circumference thereof. The coupling protrusions 34b extend downward to be fitted in PCB holes 5b formed at the PCB 5 to be coupled to the PCB 5.

For example, when the fuse block 3 with the fuse 1 of 3.15A/250V is mounted to the PCB pattern holes 7a, the knob 32a of the capacity indicating plate 32 is moved linearly along the guide slot 34a of the shielding plate 34 so that the corresponding fuse capacity of “3.15A” marked on the capacity indicating plate 32 is exposed through the opening 36 of the shielding plate 34.

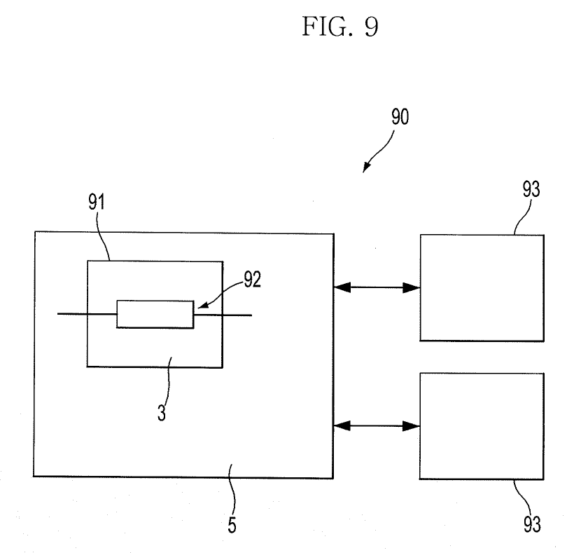

FIG. 9 is a view illustrating an electronic apparatus 90 having a device 91 to indicate a fuse capacity according to an embodiment of the present general inventive concept. Referring to FIGS. 3-9, the electronic apparatus 90 includes an electrical component 93, and the device 91 similar to the device of FIGS. 3-8 to indicate the fuse capacity of a fuse mounted in the electronic apparatus 90. The electronic apparatus 90 may be home appliances, such as an air conditioner, office machines, etc.

As apparent from the above description, the device to indicate the fuse capacity according to the present general inventive concept can easily indicate the fuse capacity in the electric apparatus which uses various fuses having different capacities on the PCB.

Also, by modifying the PCB patterns on the PCB which is commonly used in various electric apparatuses, according to the selective mounting position of the fuse at the PCB patterns, the capacity of the fuse actually mounted on the PCB can be easily indicated without additional indicating process.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. A device to indicate a fuse capacity, comprising:
a fuse;
a printed circuit board (PCB), on which the fuse is mounted; and
a capacity indicating part to expose one of different fuse capacities, corresponding to the fuse mounted on the PCB, and to shield the other fuse capacities.

2. The device according to claim 1, wherein the capacities of fuses to be mounted on the PCB are different from each other.

3. The device according to claim 1, wherein the PCB is formed with holes to determine mounting position of the fuse on the PCB according to the fuse capacity.

4. The device according to claim 3, wherein the mounting position of the holes comprises a first mounting position to indicate a first fuse capacity of the different fuse capacities and a second mounting position to indicate a second fuse capacity.

5. The device according to claim 4, wherein when:
the fuse is mounted to the first mounting position, the capacity indicating part indicates the first fuse capacity; and
when the fuse is mounted to the second mounting position, the capacity indicating part indicates the second fuse capacity.

6. The device according to claim 1, wherein the capacity indicating part comprises a capacity indicating plate, on which the different fuse capacities are marked, and a shielding plate which exposes one of the different fuse capacities marked on the capacity indicating plate, corresponding to the fuse mounted on the PCB, and shields other fuse capacities.

7. The device according to claim 6, wherein the capacity indicating plate comprises a circular plate to rotate with respect to the PCB.

8. The device according to claim 6, wherein the capacity indicating plate comprises a moving plate to move with respect to the PCB linearly.

9. The device according to claim 6, wherein the capacity indicating plate movably disposed between the PCB and the shielding plate, and the shielding plate is coupled to the PCB, and formed with an opening, through which the fuse capacity corresponding to the fuse mounted on the PCB is exposed.

10. An electronic apparatus comprising:
an electrical component;
a printed circuit board (PCB);
a fuse unit mounted on the PCB to control a power supplied to the electrical component; and
a capacity indicating part having a plurality of different capacities to expose one of the different capacities to correspond to a fuse mounted on the PCB, and to shield the other one of the different capacities.

11. The electronic apparatus according to claim 10, wherein the other one of the different capacities do not have a mark formed on the other capacities to indicate deletion of the other capacities.

12. The electronic apparatus according to claim 10, wherein:
the fuse unit comprises a fuse block mounted on the PCB to include the fuse, and the fuse block shields the other one of the different capacities.

13. The electronic apparatus according to claim 10, wherein the PCB comprises a first PCB pattern to be connected by the fuse unit to correspond to the one of the different capacities, and a second PCB pattern to be connected by a second fuse unit to correspond to the other one of the different capacities.

14. The electronic apparatus according to claim 10, wherein the PCB comprises an electrical pattern to be connected by the fuse unit, and the plurality of different capacities are formed on the electrical pattern.

15. The electronic apparatus according to claim 10, wherein the capacity indicating part comprises a plate formed with the plurality of different capacities, and a fixing plate having an opening to expose the one of the different capacities and a portion to shield the other one of the different capacities.

16. The electronic apparatus according to claim 10, wherein the PCB comprises opposite conductive ends to be electrically connected by the fuse unit, and the opposite conductive ends comprises first pattern holes and second pattern holes to be connected by the fuse unit and a second fuse unit, respectively.

17. The electronic apparatus according to claim 10, wherein the PCB comprises first and second conductive ends to be electrically connected by the fuse unit, and the fuse unit comprises a first end connected to the first conductive end by a first length, and a second end connected to the second conductive end by a second length.

18. The electronic apparatus according to claim 10, wherein the PCB comprises first and second conductive ends to be electrically connected by the fuse unit, and the fuse unit comprises a first end overlapping with the first conductive end by a first area, and a second end overlapping with the second conductive end by a second area.
